(19) United States
(12) Patent Application Publication
(10) Pub. No.: US 2026/0367706 A1
(43) Pub. Date: Nov. 19, 2026

(54) SYSTEM, METHOD AND APPARATUS FOR PROVIDING HAPTIC FEEDBACK SHOCK TO USERS IN A VR ENVIRONMENT

(71) Applicant: V-Armed Inc., New York, NY (US)

(72) Inventor: Elad Dabush, Herzliya (IL)

(73) Assignee: V-Armed Inc., New York, NY (US)

(21) Appl. No.: 19/557,209

(22) Filed: Mar. 5, 2026

Related U.S. Application Data
(60) Provisional application No. 63/767,585, filed on Mar. 6, 2025.

(51) Int. Cl. G06F 3/01

(52) U.S. Cl. CPC G06F 3/016

(57) ABSTRACT

The haptic feedback device integrates with virtual reality (VR) simulators to replicate the sensation of ballistic impact during training, enhancing immersion and realism. The device employs one or more shock coils from transcutaneous electrical nerve stimulation (TENS) devices, providing localized, real-time feedback to simulate impact sensations. Configured for easy integration with existing VR platforms, the device is worn on a belt with single-use TENS electrode pads placed on the upper chest (anterior) and shoulder blades (posterior), completing the electrical circuit. This example configuration allows the user to experience realistic haptic feedback, increasing engagement and effectiveness in training scenarios that require a physical response to simulated impacts. The device is particularly suited for VR training environments where accurate and immersive simulation of ballistic impacts is essential, improving training outcomes for users in various fields, including military, law enforcement, and emergency response.

### CROSS-REFERENCE TO RELATED APPLICATIONS

This application is a U.S. Non-Provisional Utility Patent Application entitled, “SYSTEM, METHOD AND APPARATUS FOR PROVIDING HAPTIC FEEDBACK SHOCK TO USERS IN A VR ENVIRONMENT,” which claims priority to co-pending U.S. Provisional Patent Application No. 63/767,585, filed on Mar. 6, 2025, entitled, “SYSTEM, METHOD AND APPARATUS FOR PROVIDING HAPTIC FEEDBACK SHOCK TO USERS IN A VR ENVIRONMENT”, the contents of which are hereby fully incorporated by reference.

### FIELD OF THE EMBODIMENTS

The present disclosure relates to a training device and haptic feedback systems configured to enhance immersive virtual reality (VR) training. More particularly, the disclosed embodiments pertain to a wearable feedback device that utilizes transcutaneous electrical nerve stimulation (TENS) and vibration mechanisms to simulate the sensation of being shot during VR-based training scenarios.

### BACKGROUND OF THE EMBODIMENTS

Current training in many high-risk professions, such as law enforcement and military operations, requires realistic simulations that prepare individuals for the physical and psychological demands of real-world scenarios. Traditional training methods often rely on visual and auditory feedback, which fail to replicate the physical consequences of mistakes, reducing their impact on decision-making and tactical execution. While force-on-force training with simulated ammunition can introduce physical consequences, it is costly, requires extensive safety measures, and may still lack the physiological realism needed to reinforce effective learning. Additionally, VR training environments, despite their immersive visual and interactive capabilities, often lack a tangible feedback mechanism that conditions trainees to respond appropriately under pressure. The absence of realistic consequences in VR-based training can lead to ineffective learning, as participants do not experience the physical stressors associated with combat or tactical engagements. Therefore, there is a need for a system that enhances VR training by introducing physical feedback in a controlled and adjustable manner, creating a more immersive, effective, and safe training experience.

Another challenge in training for high-risk situations is the development of stress inoculation, preparing individuals to perform effectively under pressure. Without experiencing the physiological effects of real-world encounters, trainees may struggle to translate their skills into actual field performance. Stress responses, such as elevated heart rate, muscle tension, and heightened situational awareness, are crucial components of effective decision-making in high-stakes environments. However, traditional VR training lacks a mechanism to elicit these responses, resulting in a training experience that may not fully prepare users for real-world encounters. Without a physical consequence for mistakes, trainees may develop unrealistic expectations of engagement dynamics, potentially leading to poor tactical execution in actual scenarios.

Furthermore, many existing training solutions often fail to provide consistent, scalable, and cost-effective methods for reinforcing proper technique and decision-making. Live-action training, such as force-on-force exercises or physical simulation drills, requires extensive logistical support, specialized equipment, and trained personnel, making it difficult to implement on a large scale. Additionally, pain-based training methods, such as simulated ammunition or impact-based feedback systems, can introduce safety concerns and may not be feasible for all training environments. This lack of accessibility and adaptability limits the effectiveness of training programs, particularly for organizations that rely on VR simulations as a primary training tool. Consequently, there is a need for an integrated solution that bridges the gap between immersive VR training and realistic physical feedback, ensuring that trainees develop both the cognitive and physiological responses necessary for real-world performance.

### SUMMARY OF THE EMBODIMENTS

In some aspects, the techniques described herein relate to a wearable electrical stimulation device for virtual reality training, including: a housing configured to be worn on a user; one or more electrodes having a first end electrically connected to circuitry disposed within the housing and an opposite second end configured to couple to a body of the user; the circuitry disposed within the housing, the circuitry including: a control board including a microcontroller and non-volatile memory; four independently addressable electrical stimulation output channels, each including a dedicated stimulation driver circuit configured to deliver transcutaneous electrical nerve stimulation signals to the one or more electrodes via the first end; a wireless communication module configured to receive simulated impact data from a virtual reality simulator platform; an inertial measurement unit configured to detect motion and initiate a sleep mode when the wearable electrical stimulation device is inactive; a power source disposed within the housing; and a shutdown actuator configured to interrupt electrical output from the four independently addressable electrical stimulation output channels; wherein the microcontroller is configured to: process runtime simulated impact event data received from the virtual reality simulator platform; reassign, during operation, at least one of the four independently addressable electrical stimulation output channels to a selected one of the one or more electrodes by accessing and updating a reconfigurable channel-to-electrode association table stored in the non-volatile memory; selectively activate one or more of the four independently addressable electrical stimulation output channels simultaneously to simulate spatially distinct impact locations; generate a multi-stage stimulation sequence including an initial pulse followed by sustained stimulation; enforce firmware-based limits on stimulation intensity, pulse width, pulse frequency, and activation duration independent of commands received from the virtual reality simulator platform; and default the wearable electrical stimulation device to a safe state by disabling the four independently addressable electrical stimulation output channels upon detection of communication loss.

In some aspects, the techniques described herein relate to a method of providing electrical stimulation feedback in a virtual reality training environment, including: receiving simulated impact data from a virtual reality simulator platform at a wearable electrical stimulation device including a housing, one or more electrodes electrically coupled to circuitry disposed within the housing, a microcontroller, non-volatile memory, and two or more independently addressable electrical stimulation output channels; processing runtime simulated impact event data using the microcontroller; reassigning, during operation of the wearable electrical stimulation device, at least one of the two or more independently addressable electrical stimulation output channels to a selected one of the one or more electrodes by accessing and updating a channel-to-electrode association table stored in the non-volatile memory; concurrently activating at least two of the two or more independently addressable electrical stimulation output channels to simulate spatially distinct impact locations on a body of a user; generating a multi-stage stimulation sequence including an initial pulse followed by sustained stimulation; enforcing firmware-based limits on stimulation intensity, pulse width, pulse frequency, and activation duration independent of commands received from the virtual reality simulator platform; and defaulting the wearable electrical stimulation device to a safe state by disabling the two or more independently addressable electrical stimulation output channels upon detection of communication loss.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 depicts a front perspective view of an example housing for a haptic feedback device configured to be implemented in VR training according to at least some embodiments described herein.

FIG. 2 depicts a front perspective view of another example housing for a haptic feedback device configured to be implemented in VR training according to at least some embodiments described herein.

FIG. 3 depicts a rear cut-away view of the haptic feedback device of FIG. 1 and/or FIG. 2, showing hardware components retained with a housing according to at least some embodiments described herein.

FIG. 4 depicts a top cut-away view of the haptic feedback device of FIG. 3, showing hardware components retained with a housing according to at least some embodiments described herein.

FIG. 5 depicts a front perspective view of the haptic feedback device of FIG. 3, showing a front wall surface of the housing having a button retained within an opening, according to at least some embodiments described herein.

FIG. 6 is a block diagram illustrating a wearable electrical stimulation device, according to some embodiments.

FIG. 7 is a block diagram further illustrating the wearable electrical stimulation device from FIG. 6, according to some embodiments.

FIG. 8 is a flowchart illustrating a method of providing electrical stimulation feedback in a virtual reality training environment, according to some embodiments.

FIG. 9 illustrates a front perspective view of an embodiment of an example housing for a haptic feedback device configured to be implemented in VR training, according to at least some embodiments described herein.

### DESCRIPTION OF THE PREFERRED EMBODIMENTS

The present disclosure may be better understood, and its numerous features and advantages made apparent to those skilled in the art, by referencing the accompanying drawings. The use of the same reference symbols in different drawings indicates similar or identical items.

The device is configured to integrate with a VR simulator platform, providing real-time feedback to users in tactical and high-stakes training environments, such as law enforcement and military applications. The system includes wireless communication, adjustable stimulation parameters, and an emergency shutdown feature, facilitating both effective and safe training experiences. In some embodiments, a wearable haptic feedback device is configured to enhance realism in VR training environments. The device utilizes TENS technology and an integrated vibrating motor to simulate the sensation of being shot, providing immediate and realistic feedback to trainees. The system is configured to be worn on a user's belt and delivers electrical stimulation through single-use electrode pads and/or pogo pins placed on the upper chest and shoulder blade areas of a user.

As noted above, the device operates wirelessly using a Sub-G communication protocol, allowing integration with a VR simulator platform that detects virtual shots. When a hit is registered, the control unit modulates electrical stimulation and vibration feedback to mimic the impact and aftereffects of a gunshot. The device features dual output channels to differentiate between front and back impacts, and the intensity of feedback can be adjusted via software. Additional components include an inertial measurement unit (IMU) that enables a sleep mode when the device is inactive, RGB LEDs for status indication, and a USB Type-C rechargeable battery with an onboard power level indicator. An emergency shutdown button is also incorporated to immediately disable all haptic feedback. The system is configured to improve training outcomes for high-stakes professions by introducing a physical consequence to errors, reinforcing proper decision-making and tactical execution.

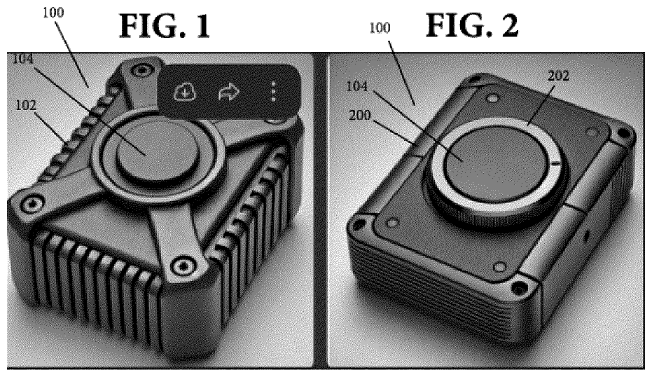

FIGS. 1-9 illustrate example methods and systems for a haptic feedback device comprising a housing, configured to encase and protect the internal components of the device. The device includes a printed circuit board (PCB), which processes signals and controls the activation of the haptic feedback mechanism. The power and charging system includes a rechargeable battery and a USB Type-C charging port, which supply power to the device. The haptic feedback mechanism is configured to deliver tactile feedback and/or TENS-based stimulation to the user, typically through a vibrating motor and/or electrode attachment. To ensure stability and proper alignment, the device incorporates mounting and structural supports that secure and stabilize the internal components within the housing. User interface components, such as control buttons and LED indicators, allow the user to interact with the device and provide operational feedback.

In one embodiment, the housing and enclosure are constructed from durable materials such as plastic, metal, or composite materials. The PCB includes a microcontroller that adjusts the intensity and frequency of the haptic feedback based on user input. The power and charging system further allows the device to operate continuously for a predetermined duration, via a battery, such as a rechargeable battery. The haptic feedback mechanism is configured to simulate physical sensations such as pressure, texture, or motion, providing an immersive user experience. In addition, the user interface includes an emergency shutdown feature, allowing the user to deactivate the device for safety reasons. The mounting and structural supports, including brackets, screws, or adhesive elements, are responsible for securing the PCB, power components, and haptic feedback mechanism within the housing. The PCB also includes sensors that detect user interaction with the device and adjust the haptic feedback accordingly.

FIG. 1 illustrates an example housing 102 for a haptic feedback device 100 configured to be implemented in VR training. The button 104 (FIGS. 1-5) functions as an emergency shutdown mechanism, allowing a user to disable the haptic feedback when pressed. This feature facilitates user safety by providing a means to terminate electrical stimulation and/or vibration feedback in cases of discomfort, system malfunction, and/or unintended activation. Upon depression, the button triggers a hardware-level interrupt, cutting power to the haptic output circuits and ceasing all feedback transmission in real time. This configuration enhances operational reliability and user control, making the device safer for training environments where rapid response to physical stimuli is more desirable.

FIG. 2 illustrates another example housing 200 for the haptic feedback device 100 configured to be implemented in VR training. A rotatable bezel 202 is positioned around the button 104 and is configured to be rotated, allowing users to adjust the intensity of the electrical stimulation emitted by the haptic feedback device 100. This configuration enables control over the level of haptic feedback, providing customizable stimulation based on user preferences or training requirements. By incorporating a mechanical adjustment mechanism, the bezel enhances usability while facilitating integration with the device's electrical output system.

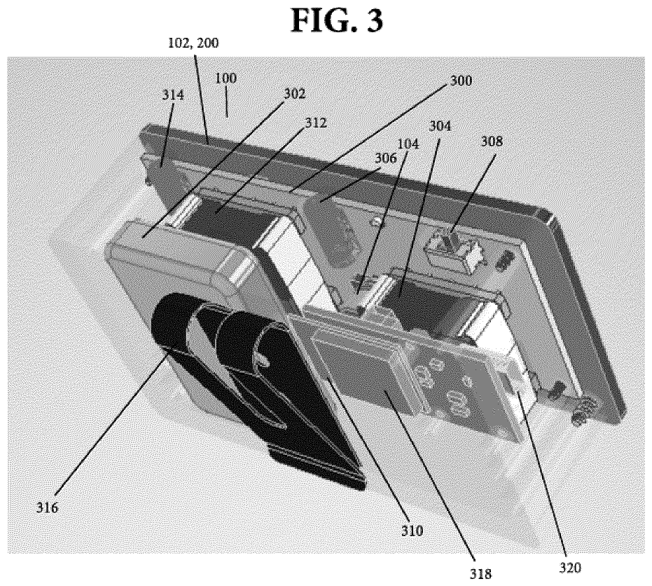

FIG. 3 illustrates the haptic feedback device 100 of FIG. 1 and/or FIG. 2 showing hardware components retained with the housing 102, 200. The housing 102, 200 serves as the main structural component, encasing and protecting the internal electronics. A primary printed circuit board (PCB) 300 is configured for processing signals and controlling the haptic feedback. A battery 302 and a USB Type-C charging port 320 provide the power for operation and recharging. A first shock coil 304 of a first TENS device is disposed between the primary PCB 300 and a secondary PCB 310. The first shock coil 304 of the first TENS device is electrically coupled to a first end of a first connector 306. The first end of the first connector 306 receives an end of a first conductive material (not shown), such as a wire, connected to one or more shocker pads (not shown) and/or pogo pins (not shown) configured to emit an electrical stimulation to a first location of a user's body.

A second shock coil 312 of a second TENS device is disposed between the primary PCB 300 and the battery 302. The second shock coil 312 of the second TENS device is electrically coupled to a first end of a second connector 314. The first end of the second connector 314 receives an end of a second conductive material (not shown), such as a wire, connected to one or more shocker pads (not shown) and/or pogo pins (not shown) configured to emit an electrical stimulation to a second location of a user's body. In an embodiment, the one or more shocker pads are positioned in a first location of a user's body including, but not limited to, the upper chest and a second location of a user's body including, but not limited to, the shoulder blade regions at the back, with two pads per side to establish a complete electrical circuit. Upon detection of a simulated gunshot event, the device delivers an initial sharp, high-frequency pulse, immediately followed by sustained muscle stimulation, effectively mimicking the impact and residual effects of a ballistic hit. This mechanism induces a physical response that closely replicates real-world conditions, reinforcing situational awareness, tactical discipline, and decision-making under duress. By introducing a tangible consequence for errors, the system enhances cognitive and motor skill reinforcement, ultimately improving training efficacy in high-stakes operational environments.

A clip 316 is configured for securing the housing 102, 200 to a user's belt (not shown). On/off switch 308 is electrically coupled to the primary PCB 300. Wireless processor 318 is in electrical communication with the secondary PCB 310, enabling the transmission and processing of wireless signals for the haptic feedback device. This connection facilitates real-time control of the system's functions, including impact detection, intensity adjustments, and feedback delivery, facilitating integration with the device's electrical and communication architecture.

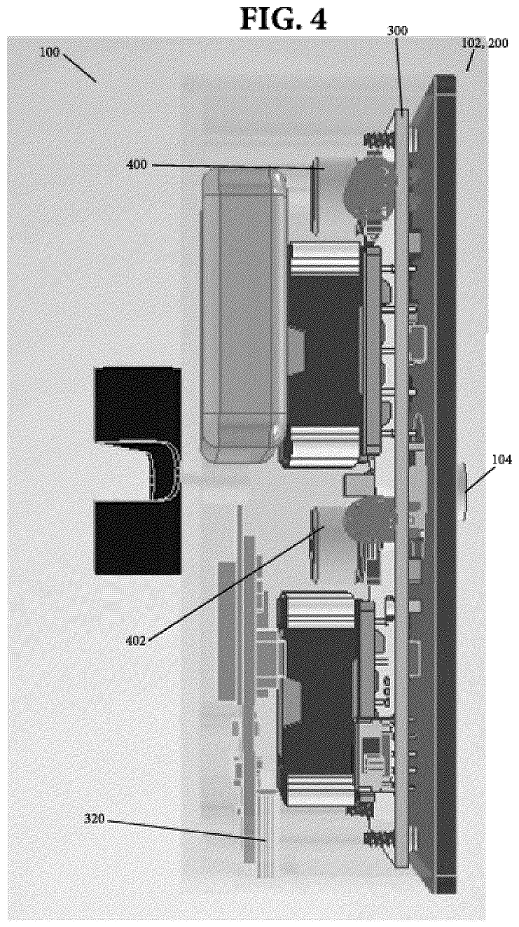

FIG. 4 illustrates the haptic feedback device 100 of FIG. 3 showing hardware components retained with the housing 102, 200. In addition to the shock feedback, one or more vibrating motors are integrated into the haptic feedback device 100 to provide multiple feedback options, enhancing the realism and versatility of the training experience for different scenarios. The device includes a first motor 400 and a second motor 402, both electrically connected to the primary PCB 300, configured for differentiation between front and back shots, for example. When a shot is detected, the haptic feedback device activates both the shock mechanism and the vibrating motor to simulate a more comprehensive and realistic response. The vibrating motor provides an additional layer of sensory feedback, which is particularly useful for replicating the sensation of a shot or impact that does not involve a strong, localized shock but still requires a noticeable physical response. This vibration is configured to convey different intensities and patterns, depending on the scenario. For instance, a light vibration may indicate a near miss, while a stronger vibration could represent a more direct hit. The combination of shock and vibration feedback enhances the overall immersion by offering a range of tactile sensations, allowing users to perceive the impact in more nuanced ways. This dual-feedback system ensures that the user experiences a full spectrum of sensations, improving the realism and engagement of the training environment.

In an embodiment, the device utilizes the Sub-G wireless protocol, which is consistent with the current shot detection system, facilitating communication. An Inertial Measurement Unit (IMU) is incorporated to enable sleep mode functionality, optimizing power consumption. The device also features RGB LEDs for visual feedback and includes charging capabilities, similar to the V-Armed Sub-G Board, ensuring efficient operation and ease of maintenance.

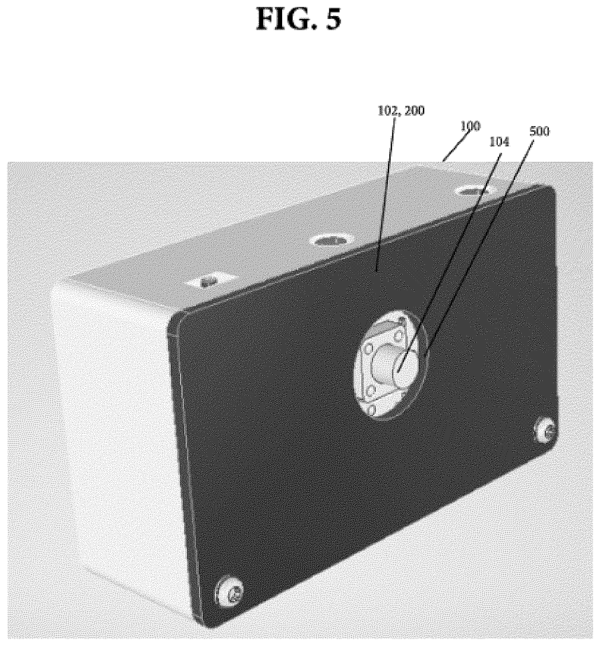

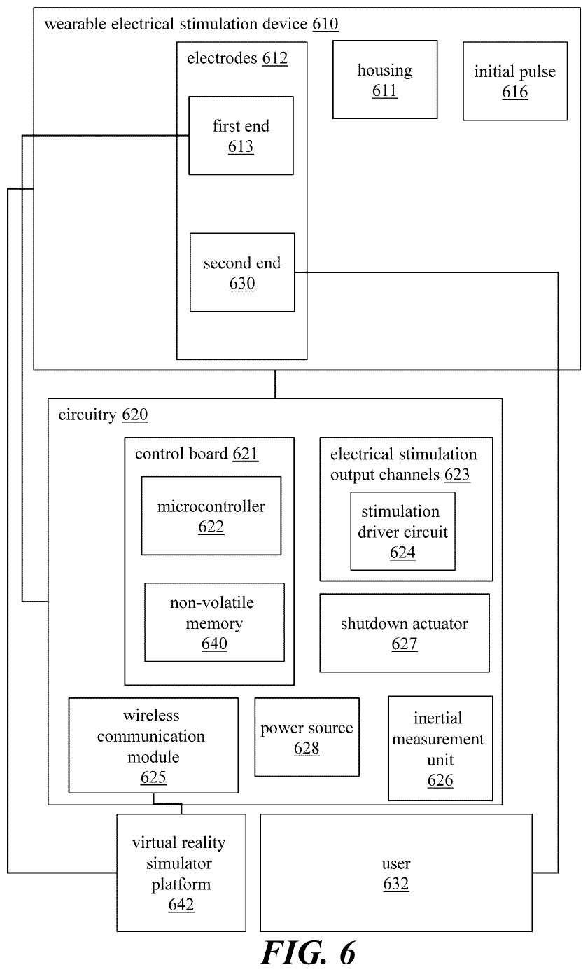

FIG. 5 illustrates the haptic feedback device 100 of FIG. 3 showing a front wall surface of the housing 102, 200 having the emergency shutoff button retained within an opening 500. The emergency shutoff button is configured for easy access by the user, enabling quick and efficient activation in the event of an emergency or when immediate power deactivation is required for safety or troubleshooting purposes. The button is positioned to be easily identifiable and operable, even during high-intensity scenarios. The housing is constructed with durable materials to safeguard the button while maintaining a streamlined and functional design. This emergency shutoff feature allows for the rapid cessation of device functions, including shock and vibration feedback, in case of system malfunction, user discomfort, or other unforeseen conditions. The configuration of the button ensures user safety by providing a reliable means of interrupting device operation as needed. Referring to FIG. 6, a wearable electrical stimulation device 610 is illustrated in functional block diagram form. The wearable electrical stimulation device 610 comprises a housing 611 that physically contains and supports circuitry 620. The housing 611 mechanically supports the control board 621, electrical stimulation output channels 623, wireless communication module 625, power source 628, inertial measurement unit 626, and shutdown actuator 627. The electrodes 612 extend externally from the housing 611 and are electrically coupled to circuitry 620. The wearable electrical stimulation device 610 is configured to communicate electronically with a virtual reality simulator platform 642, and is further configured to provide electrical stimulation to a user 632 via the electrodes 612.

The electrodes 612 include a first end 613 that is electrically connected to the electrical stimulation output channels 623 within circuitry 620. The electrical connection may be established through conductive wiring, shielded cables, snap connectors, or pogo pin interfaces. The electrodes 612 further include a second end 630 that is configured to contact the body of the user 632. Electrical current generated by the stimulation driver circuits 624 flows from the electrical stimulation output channels 623 through the first end 613, across the electrode body, and into the user's tissue via the second end 630. In embodiments utilizing electrode pairs, current may return through a corresponding paired electrode to complete the stimulation circuit. The electrodes 612 therefore provide a conductive pathway between the internal stimulation circuitry and the user's body.

The control board 621 includes a microcontroller 622 and non-volatile memory 640. The microcontroller 622 is electrically coupled to the wireless communication module 625 and receives simulated impact event data from the virtual reality simulator platform 642 through the wireless communication module 625. The wireless communication module 625 establishes a bidirectional communication link with the virtual reality simulator platform 642 using a wireless protocol such as Sub-GHz radio, WiFi, or Bluetooth. Data packets containing impact location, intensity, and timing information are transmitted from the virtual reality simulator platform 642 and received by the wireless communication module 625. The wireless communication module 625 conveys the received data to the microcontroller 622 via a digital interface such as SPI, UART, or I2C. The microcontroller 622 processes the received data to determine appropriate stimulation commands.

The microcontroller 622 is electrically coupled to each of the four independently addressable electrical stimulation output channels 623. Each electrical stimulation output channel 623 includes a stimulation driver circuit 624 that generates controlled electrical pulses. Control signals generated by the microcontroller 622 are transmitted to the stimulation driver circuits 624 to define pulse amplitude, pulse width, pulse frequency, and activation duration. Electrical output generated by the stimulation driver circuits 624 is delivered to the electrodes 612 through conductive traces and connectors. Each of the four independently addressable electrical stimulation output channels 623 may operate independently, enabling separate or concurrent activation.

During operation, the microcontroller 622 processes runtime simulated impact event data received from the virtual reality simulator platform 642. Based on the processed event data, the microcontroller 622 accesses a channel-to-electrode association table stored in non-volatile memory 640. The channel-to-electrode association table defines logical relationships between specific electrical stimulation output channels 623 and selected electrodes 612. The microcontroller 622 may update the channel-to-electrode association table during operation to reassign at least one of the four independently addressable electrical stimulation output channels 623 to a selected one of the electrodes 612. The reassignment modifies the logical routing of stimulation signals without requiring any change to the physical wiring connections between the circuitry 620 and the electrodes 612.

The microcontroller 622 may selectively activate one or more of the four independently addressable electrical stimulation output channels 623 simultaneously. When simultaneous activation is commanded, control signals are transmitted from the microcontroller 622 to multiple stimulation driver circuits 624 within the electrical stimulation output channels 623. Each activated stimulation driver circuit 624 generates electrical pulses that are conveyed through the electrodes 612 to anatomically distinct regions of the user 632. Concurrent activation of multiple channels produces spatially distinct stimulation effects corresponding to simulated impact locations indicated by the virtual reality simulator platform 642. Sequential activation may also be performed by issuing timed activation signals to individual channels in rapid succession.

The microcontroller 622 generates a multi-stage stimulation sequence that includes an initial pulse 616 followed by sustained stimulation. The initial pulse 616 may comprise a short-duration, higher-frequency stimulation burst generated by one or more stimulation driver circuits 624. Following completion of the initial pulse 616, the microcontroller 622 commands continued stimulation at different pulse parameters to create sustained stimulation. The sustained phase may be characterized by reduced frequency, reduced amplitude, or modified pulse width relative to the initial pulse 616. Control signals defining the multi-stage sequence are issued by the microcontroller 622 to the stimulation driver circuits 624 in accordance with predefined stimulation profiles stored in non-volatile memory 640.

The firmware executed by the microcontroller 622 enforces limits on stimulation intensity, pulse width, pulse frequency, and activation duration independent of commands received from the virtual reality simulator platform 642. Before transmitting activation commands to the stimulation driver circuits 624, the microcontroller 622 compares requested parameter values to maximum threshold values stored in non-volatile memory 640. If requested parameters exceed allowable limits, the microcontroller 622 modifies the parameters to remain within defined safety constraints. This validation process occurs internally within circuitry 620 and does not rely on the virtual reality simulator platform 642 to enforce safety thresholds. The shutdown actuator 627 is electrically coupled to circuitry 620 and, when actuated, interrupts electrical output from the four independently addressable electrical stimulation output channels 623 by generating a control signal that disables the stimulation driver circuits 624.

The microcontroller 622 monitors the communication status between the wireless communication module 625 and the virtual reality simulator platform 642. If the microcontroller 622 detects loss of communication, such as absence of expected data packets within a predefined time interval, the microcontroller 622 transitions the wearable electrical stimulation device 610 to a safe state. In the safe state, the microcontroller 622 disables the four independently addressable electrical stimulation output channels 623 by ceasing transmission of activation signals to the stimulation driver circuits 624. The safe state may also include clearing queued stimulation commands and preventing reactivation until communication is restored. Restoration of communication between the wireless communication module 625 and the virtual reality simulator platform 642 is required before normal operation resumes.

The inertial measurement unit 626 is electrically coupled to the microcontroller 622 and provides motion data indicative of movement of the wearable electrical stimulation device 610. If the inertial measurement unit 626 indicates prolonged inactivity, the microcontroller 622 may reduce system power consumption by placing circuitry 620 into a sleep mode. The power source 628 supplies electrical energy to all components within circuitry 620, including the control board 621, stimulation driver circuits 624, wireless communication module 625, and inertial measurement unit 626. Power management circuitry regulates voltage supplied by the power source 628 to maintain stable operation. Together, these components establish a coordinated system in which data received from the virtual reality simulator platform 642 is processed by the microcontroller 622 and translated into controlled electrical stimulation delivered to the user 632 through the electrodes 612.

In some embodiments, a technical benefit of the wearable electrical stimulation device includes dynamic reassignment of independently addressable electrical stimulation output channels to selected electrodes during runtime operation. The reassignment may be performed by accessing and updating a reconfigurable channel-to-electrode association table stored in non-volatile memory. By performing mapping operations at the firmware level rather than through fixed hardware routing, the system may accommodate changes in electrode placement without requiring physical rewiring. This configuration may allow a single hardware device to support multiple anatomical configurations and user body geometries. For example, in some embodiments, if electrode positions are relocated from an upper chest region to a lateral torso region, the microcontroller may update the mapping table to preserve spatial correspondence with simulated impact data. Such runtime reconfiguration may reduce hardware complexity and improve deployment flexibility across varied training environments.

In some embodiments, the use of multiple independently addressable electrical stimulation output channels provides improved spatial and temporal control of stimulation delivery. Each output channel may include a dedicated stimulation driver circuit configured to independently control amplitude, pulse width, pulse frequency, and activation duration. This independently addressable architecture may allow concurrent activation of multiple channels to simulate compound impact events. For example, in some embodiments, simultaneous activation of front and rear channels may simulate multiple directional threats occurring within a virtual training scenario. In other embodiments, sequential activation with minimal latency may simulate motion of impact across a user's torso. The ability to independently control each channel may improve spatial fidelity and perceptual differentiation compared to single-channel stimulation systems.

In some embodiments, generation of a multi-stage stimulation sequence provides enhanced realism and differentiated impact simulation. The multi-stage sequence may include an initial pulse followed by sustained stimulation. The initial pulse may comprise a short-duration, higher-frequency burst intended to simulate an immediate impact sensation. The sustained stimulation phase may operate at a different frequency or amplitude to simulate residual muscular response. By separating stimulation into distinct stages, the device may enable independent control over onset intensity and persistence characteristics. This staged waveform architecture may allow firmware-based adjustment of stimulation profiles corresponding to different simulated threat levels.

In some embodiments, firmware-based enforcement of stimulation parameter limits provides enhanced operational safety and predictability. The microcontroller may compare requested stimulation parameters to predefined threshold values stored in non-volatile memory prior to activation of stimulation driver circuits. If a received command exceeds allowable intensity, pulse width, frequency, or duration limits, the microcontroller may modify the parameters to remain within safe boundaries. This local enforcement mechanism may operate independently of commands received from the virtual reality simulator platform. As a result, stimulation output may remain within predetermined safety constraints even if external data packets are corrupted or improperly formatted. Such firmware-level validation may improve robustness and electrical safety of the wearable system.

In some embodiments, automatic transition to a safe state upon detection of communication loss provides additional reliability. The microcontroller may monitor connectivity status with the virtual reality simulator platform using heartbeat signals or timed acknowledgment intervals. If communication is interrupted beyond a predefined timeout threshold, the microcontroller may disable all independently addressable electrical stimulation output channels. This safe-state transition may prevent unintended continuous stimulation in the absence of verified control signals. In some embodiments, reactivation of stimulation output may require re-establishment of authenticated communication. This communication-dependent control logic may enhance system reliability in wireless operating environments.

In some embodiments, integration of an inertial measurement unit provides benefits related to power management and device responsiveness. The inertial measurement unit may detect motion of the wearable electrical stimulation device and provide movement data to the microcontroller. If inactivity is detected for a predetermined duration, the microcontroller may transition the device into a low-power sleep mode to conserve battery energy. Upon renewed motion detection, the device may automatically resume operational readiness without manual intervention. This motion-responsive control may extend battery runtime and reduce unnecessary power consumption. Integration of motion detection with stimulation logic may therefore improve energy efficiency and operational convenience.

In some embodiments, the combination of dynamic channel mapping, independently addressable output channels, multi-stage waveform generation, firmware-enforced safety limits, communication-based fail-safe operation, and motion-responsive power management provides a technically improved wearable electrical stimulation architecture. The coordinated interaction of these components may enable precise spatial mapping of simulated impact events to anatomical electrode locations. The architecture may further permit runtime reconfiguration without hardware modification. Safety enforcement mechanisms may operate locally within the device to ensure predictable stimulation behavior. Collectively, these structural and firmware-based features may provide enhanced realism, improved adaptability, and controlled electrical output in virtual reality training applications.

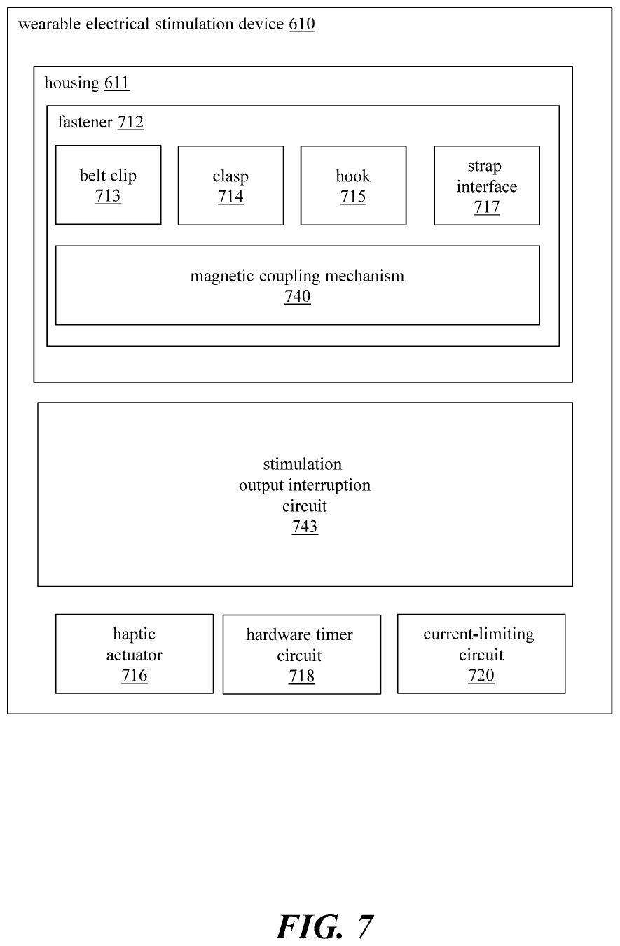

Referring to FIG. 7, a wearable electrical stimulation device 610 is illustrated, including additional structural and safety-related components integrated within housing 611. In some embodiments, at least two of the four independently addressable electrical stimulation output channels are configured to deliver differential stimulation to a front portion and a back portion of the body of the user via the one or more electrodes. A first subset of the electrical stimulation output channels may be logically mapped to electrodes positioned on an anterior chest region of the user, while a second subset may be mapped to electrodes positioned on a posterior shoulder blade region. Differential stimulation may include variation in amplitude, pulse width, pulse frequency, phase polarity, activation timing, or waveform shape between the front and rear channels. For example, anterior stimulation may include a higher-amplitude initial pulse followed by shorter sustained stimulation, while posterior stimulation may include a delayed onset or staggered activation to simulate directional impact. The independently addressable architecture permits each channel to be configured with separate stimulation parameters, thereby enabling anatomically distinct and directionally representative feedback.

In some embodiments, the wearable electrical stimulation device 610 further comprises at least one haptic actuator 716 configured to provide optional vibration feedback in response to simulated impact data. The haptic actuator 716 may comprise an eccentric rotating mass motor, a linear resonant actuator, a voice coil actuator, or a piezoelectric vibration element disposed within housing 611. The haptic actuator 716 may be electrically coupled to the control board and controlled by firmware instructions executed by the microcontroller. Activation of the haptic actuator 716 may occur in response to simulated impact events, environmental cues, or proximity alerts generated by the virtual reality simulator platform. Vibration intensity may be adjustable across multiple predefined levels, such as low, medium, or high amplitude vibration profiles. The inclusion of the haptic actuator 716 enables multimodal sensory output by combining mechanical vibration with electrical stimulation.

In some embodiments, the at least one haptic actuator 716 operates synchronously with at least one of the four independently addressable electrical stimulation output channels. Synchronous operation may involve concurrent activation of the haptic actuator 716 and a selected stimulation driver circuit such that vibration onset aligns temporally with the initial electrical pulse. For example, the haptic actuator 716 may begin vibrating within a predetermined interval, such as less than 10 milliseconds from initiation of electrical stimulation, to reinforce the perceived onset of impact. The vibration duration may mirror the duration of a multi-stage stimulation sequence or may follow a defined vibration profile stored in non-volatile memory. In certain embodiments, the haptic actuator 716 may operate at a frequency between approximately 100 Hz and 250 Hz while electrical stimulation is delivered. This synchronized configuration may enhance perceptual integration of tactile and electrical cues within the training environment.

In alternative embodiments, the haptic actuator 716 operates independently of the four independently addressable electrical stimulation output channels. In such embodiments, vibration feedback may be generated without electrical stimulation, or electrical stimulation may occur without concurrent vibration. For example, a simulated near-miss event may trigger vibration only, while a direct impact event may trigger both electrical and vibratory output. The control logic may independently define amplitude, duty cycle, frequency, and duration parameters for the haptic actuator 716 separate from electrical stimulation parameters. This separation allows differentiated sensory feedback profiles tailored to specific training scenarios. Independent control of vibration relative to electrical stimulation permits flexible programming of user feedback without coupling the two output modalities.

In some embodiments, the wearable electrical stimulation device 610 further comprises a stimulation output interruption circuit 743 electrically coupled between the two or more independently addressable electrical stimulation output channels and the one or more electrodes. The stimulation output interruption circuit 743 may be configured to physically interrupt electrical continuity between stimulation driver circuits and the electrodes when predetermined conditions are met. Such interruption may occur when activation duration exceeds a predetermined duration threshold, when current exceeds a predefined maximum amplitude, or when abnormal operating conditions are detected. The interruption circuit 743 may include switching elements such as field-effect transistors, relays, or solid-state isolation devices configured to open the output path. Because the interruption mechanism is implemented in hardware, termination of electrical output may occur independently of firmware execution. This hardware-based safeguard provides redundancy relative to software-enforced safety constraints.

In some embodiments, the stimulation output interruption circuit 743 comprises at least one of a hardware timer circuit 718 or a current-limiting circuit 720. The hardware timer circuit 718 may include a clock source and a counter configured to measure an activation interval of the two or more independently addressable electrical stimulation output channels. When the measured activation interval exceeds a predetermined threshold, such as approximately 1 second, 2 seconds, or another defined duration, the hardware timer circuit 718 may generate a reset or disable signal. The reset or disable signal may be electrically coupled to gating components within the stimulation driver circuits to terminate output. The current-limiting circuit 720 may include resistive components, current-sense amplifiers, or comparator circuits configured to restrict maximum output current to a defined value, such as approximately 60 mA or another selected threshold. The combined use of timing and current-limiting circuitry provides layered hardware-level control over stimulation output.

In some embodiments, housing 611 includes a fastener 712 configured to removably couple the wearable electrical stimulation device 610 to at least a portion of the user. The fastener 712 may be integrally formed with housing 611 or attached as a separate structural component. For example, fastener 712 may comprise a belt clip 713 configured to engage a waistband, tactical belt, or garment edge. The belt clip 713 may include a spring-biased retention arm to maintain engagement during movement. In other embodiments, fastener 712 may comprise a clasp 714 configured to latch onto a fabric loop or structural support. The fastener 712 enables secure positioning of the device while allowing removal for maintenance, charging, or repositioning.

In some embodiments, fastener 712 may comprise at least one of a hook 715, strap interface 717, or magnetic coupling mechanism 740. The hook 715 may be configured to engage webbing loops or load-bearing equipment straps. The strap interface 717 may allow integration with adjustable straps, elastic bands, or modular attachment systems. The magnetic coupling mechanism 740 may include one or more permanent magnets aligned with a ferromagnetic mounting plate to permit rapid attachment and detachment. Magnetic retention strength may be selected to balance stability with removability. These alternative fastening mechanisms provide flexibility for different user garments, equipment configurations, and operational requirements.

The structural and electrical features illustrated in FIG. 7 provide anatomical differentiation of stimulation delivery, multimodal sensory feedback, redundant hardware-based safety interruption, and adaptable wearable attachment mechanisms. Differential channel control enables spatially accurate front and rear stimulation. Optional haptic actuator 716 provides additional tactile signaling that may be synchronized or independent relative to electrical output. Stimulation output interruption circuit 743, hardware timer circuit 718, and current-limiting circuit 720 provide hardware-based safeguards that function independently of firmware control. Fastener 712 and associated retention mechanisms enable stable positioning of the device during movement. These integrated features enhance operational functionality and user safety within virtual reality training applications.

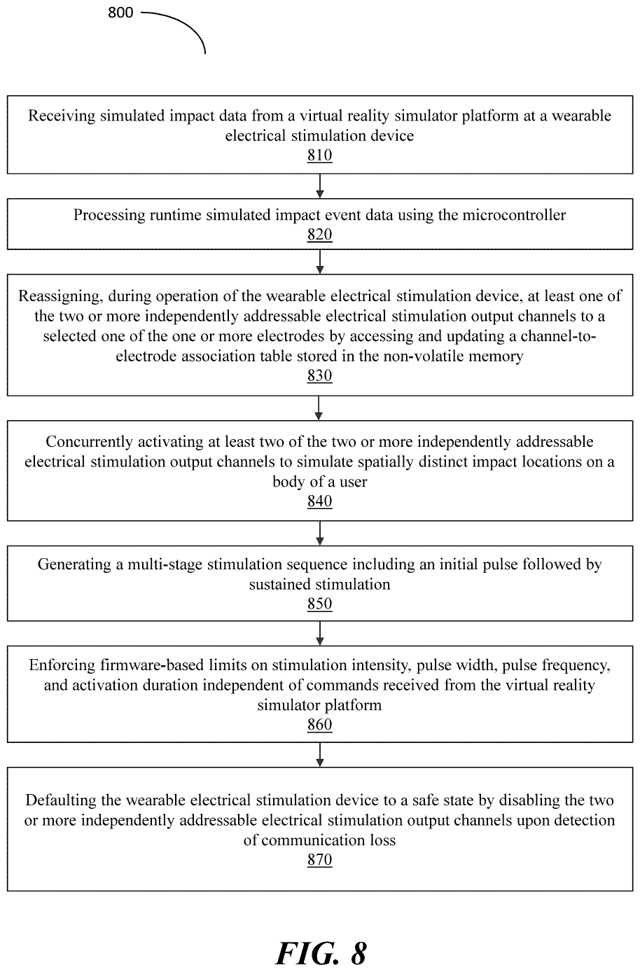

Referring to FIG. 8, a method 800 of providing electrical stimulation feedback in a virtual reality training environment is illustrated. In step 810, simulated impact data is received from a virtual reality simulator platform at a wearable electrical stimulation device. The wearable electrical stimulation device comprises a housing, one or more electrodes electrically coupled to circuitry disposed within the housing, a microcontroller, non-volatile memory, and two or more independently addressable electrical stimulation output channels. The simulated impact data may be transmitted wirelessly using a communication protocol such as Sub-GHz radio, WiFi operating at approximately 5 GHz, Bluetooth Low Energy, or another low-latency wireless communication protocol suitable for real-time interaction. The received data may include an impact identifier, anatomical location information, impact severity level, activation duration, and optional scenario classification data. Upon receipt, the data may be stored in a volatile memory buffer accessible to the microcontroller for subsequent parsing and validation.

In step 820, runtime simulated impact event data is processed using the microcontroller. Processing may include parsing received packets according to a predefined message structure that includes header fields, payload fields, and integrity verification fields. The microcontroller may perform error detection using a cyclic redundancy check, checksum comparison, or other data integrity validation mechanism to confirm accurate transmission. The microcontroller may also authenticate the source of the data using stored pairing identifiers or cryptographic verification keys. Following validation, the microcontroller extracts relevant parameters such as impact location coordinates, severity value, and requested stimulation duration. The extracted parameters may be normalized or scaled into internal stimulation parameter ranges stored in non-volatile memory for consistent application across training scenarios.

In some embodiments, “processing runtime simulated impact event data using the microcontroller” is implemented as a deterministic event-handling pipeline executed by firmware on the microcontroller. The microcontroller receives one or more data packets from the wireless communication module and places the packets into a receive buffer in RAM, such as a ring buffer or message queue. The microcontroller parses each packet according to a defined message format that includes fields such as an event identifier, a timestamp, an impact location identifier, an intensity value, and a duration value. The microcontroller validates the packet using one or more checks, such as a cyclic redundancy check, a message authentication code, a sequence number, or a replay counter, to reject corrupted or unauthorized commands. The microcontroller then normalizes or scales the received values into internal units used by stimulation control, such as mapping an intensity value into a permitted current amplitude range. The microcontroller stores the parsed and normalized event data as a structured event object, such as a fixed-length record containing impact location, intensity profile selection, and timing parameters.

In some embodiments, the microcontroller applies decision logic to determine which stimulation output channels to activate and what stimulation parameters to command. The decision logic may include a lookup into a channel-to-electrode association table stored in non-volatile memory to translate the impact location identifier into one or more target channels and target electrodes. The decision logic may further include a rules engine that selects a stimulation profile, such as Basic, Medium, or Rough, based on the received intensity value and optionally a scenario identifier. If multiple impact events are received within a time window, the microcontroller may perform arbitration using prioritization rules, such as selecting the highest severity event, merging events that share a location, or limiting a maximum number of concurrently active channels. The microcontroller may schedule stimulation activations using a timer subsystem, such as a hardware timer interrupt, to achieve precise onset timing and stage transitions. The microcontroller may also compute derived parameters, such as an initial pulse burst duration and a sustained stimulation duration, based on the selected profile.

In some embodiments, the microcontroller generates control signals for the stimulation driver circuits by writing configuration values to one or more control registers or digital interfaces that drive the stimulation output channels. The microcontroller may configure per-channel pulse width, frequency, and amplitude by setting digital-to-analog converter values, pulse-width-modulation duty cycles, or waveform generator parameters associated with each stimulation driver circuit. The microcontroller initiates a multi-stage stimulation sequence by issuing a first set of parameters for an initial pulse stage and then transitioning to a second set of parameters for a sustained stage using a timed interrupt or state machine. The microcontroller monitors the elapsed activation interval using a hardware timer or counter and terminates stimulation when the configured activation duration expires. The microcontroller may also monitor output feedback, such as sensed current, sensed voltage, or impedance estimation, to verify that commanded stimulation is being delivered within expected bounds. If measured feedback indicates an abnormal condition, such as an open electrode connection or an overcurrent condition, the microcontroller may adjust parameters or terminate output.

In some embodiments, the processing includes enforcement of safety constraints prior to enabling stimulation output. The microcontroller compares requested stimulation parameters against maximum threshold values stored in non-volatile memory and clamps parameters that exceed permitted limits. The microcontroller may also require an authenticated “armed” state prior to allowing any stimulation, such as verifying a pairing identifier, a session token, or a cryptographic signature associated with the simulated impact data. Upon detection of communication loss, the microcontroller transitions to a safe state by clearing pending events, disabling output enable lines to the stimulation driver circuits, and preventing reactivation until communication is restored. The microcontroller may maintain a heartbeat timer that is periodically reset by valid messages, and may initiate the safe-state transition when the heartbeat timer expires. These processing steps provide low-latency response to VR impact events while maintaining deterministic timing, channel mapping control, and safety enforcement.

In step 830, during operation of the wearable electrical stimulation device, at least one of the two or more independently addressable electrical stimulation output channels is reassigned to a selected one of the one or more electrodes. This reassignment is performed by accessing a channel-to-electrode association table stored in the non-volatile memory and modifying one or more mapping entries. The association table may define logical relationships between output channel identifiers and electrode positions corresponding to anatomical regions such as the anterior chest, posterior shoulder, or lateral torso. Updating the association table permits runtime reconfiguration without requiring modification of physical wiring between stimulation circuitry and electrodes. For example, if electrode placement is adjusted to accommodate different body sizes or equipment configurations, the logical mapping may be updated to preserve spatial accuracy. This dynamic reassignment step allows the system to maintain correspondence between simulated impact location and actual stimulation delivery point on the user's body.

In step 840, at least two of the two or more independently addressable electrical stimulation output channels are concurrently activated to simulate spatially distinct impact locations on a body of a user. Concurrent activation may involve issuing control signals from the microcontroller to multiple stimulation driver circuits substantially simultaneously. Each activated channel may operate with independently defined stimulation parameters, including current amplitude, pulse width, frequency, and activation duration. For example, a first channel mapped to anterior electrodes may deliver a higher-amplitude initial pulse while a second channel mapped to posterior electrodes delivers a lower-amplitude sustained response. Inter-channel latency may be controlled to less than a predetermined interval, such as 5 to 20 milliseconds, to create perceptually simultaneous activation. Independent channel control enables differentiated stimulation patterns corresponding to complex or multi-directional simulated impact events.

In step 850, a multi-stage stimulation sequence is generated, including an initial pulse followed by sustained stimulation. The initial pulse may comprise a short-duration, higher-frequency stimulation burst configured to simulate an immediate impact sensation. For example, the initial pulse may operate at a frequency between approximately 80 Hz and 150 Hz, with a pulse width between approximately 100 microseconds and 300 microseconds. Following the initial pulse, sustained stimulation may operate at a lower frequency, such as between approximately 30 Hz and 70 Hz, for a duration between approximately 300 milliseconds and 2 seconds. The transition between stages may be controlled using a hardware timer interrupt or a firmware-based state machine executed by the microcontroller. Predefined stimulation profiles corresponding to different impact severity levels may be stored in non-volatile memory and referenced during generation of the multi-stage sequence.

In step 860, firmware-based limits are enforced on stimulation intensity, pulse width, pulse frequency, and activation duration, independent of commands received from the virtual reality simulator platform. The microcontroller compares requested stimulation parameters to maximum allowable values stored in non-volatile memory prior to enabling output. If a requested parameter exceeds a defined threshold, such as a maximum current amplitude of approximately 60 mA or a maximum activation duration of approximately 2 seconds, the microcontroller modifies the parameter to comply with safety constraints. This validation process is performed locally within the wearable electrical stimulation device and does not rely on remote enforcement. In some embodiments, parameter validation may include clamping values to safe limits or rejecting activation commands entirely. The firmware-based limit enforcement provides consistent control of stimulation output, even in the event of corrupted or improperly formatted external commands.

In step 870, the wearable electrical stimulation device is defaulted to a safe state upon detection of communication loss. Communication loss may be determined by the absence of expected data packets, missed heartbeat signals, or expiration of a communication timeout interval stored within firmware. Upon detecting communication interruption beyond a predetermined threshold, the microcontroller disables the two or more independently addressable electrical stimulation output channels. Disabling may include terminating output signals, clearing pending activation instructions, and preventing reactivation until communication is restored and validated. The safe-state mechanism may also include logging the communication failure event in non-volatile memory for diagnostic purposes. This automatic transition to a safe state prevents unintended or continuous stimulation in the absence of verified control data from the virtual reality simulator platform.

The method illustrated in FIG. 8 therefore provides a structured operational sequence that integrates wireless data reception, real-time event processing, dynamic channel reassignment, concurrent multi-channel activation, staged waveform generation, firmware-enforced safety limits, and communication-based fail-safe operation. Each step interacts with defined hardware and firmware components within the wearable electrical stimulation device. The coordinated execution of these steps enables spatially differentiated and temporally controlled electrical stimulation feedback corresponding to simulated impact events. The combination of runtime mapping logic, independent channel control, and local safety enforcement provides predictable device behavior during interactive virtual training scenarios. The described method therefore establishes a controlled and adaptive electrical stimulation feedback mechanism for immersive training applications.

In some embodiments, the two or more independently addressable electrical stimulation output channels comprise four independently addressable electrical stimulation output channels. The four-channel configuration permits independent control of stimulation delivered to four distinct electrode locations positioned on a body of a user. For example, a first and second channel may correspond to electrodes positioned on an anterior portion of the torso, while a third and fourth channel may correspond to electrodes positioned on a posterior portion of the torso. Each of the four channels may include a dedicated stimulation driver circuit configured to independently control amplitude, pulse width, frequency, and activation duration. The microcontroller may selectively activate any combination of the four channels in response to simulated impact data. This four-channel architecture provides enhanced spatial resolution and increased flexibility relative to embodiments employing only two channels.

In some embodiments, the method further comprises delivering differential stimulation using at least two of the two or more independently addressable electrical stimulation output channels to a front portion and a back portion of the body of the user. Differential stimulation may include variation in amplitude, waveform shape, pulse frequency, or activation timing between channels associated with anterior and posterior electrode locations. For example, a simulated frontal impact event may cause activation of anterior channels at a higher amplitude and shorter duration, while posterior channels may be activated at a lower amplitude or with a delayed onset to simulate directional energy transfer. The microcontroller may reference stored channel-to-electrode mappings to determine which channels correspond to front and back anatomical regions. Independent control of stimulation parameters across these regions allows for differentiated perception of impact direction. This differential activation enhances spatial realism within the virtual reality training environment.

In some embodiments, the method further comprises generating vibration feedback using at least one haptic actuator of the wearable electrical stimulation device. The haptic actuator may comprise a vibrating motor, linear resonant actuator, piezoelectric actuator, or other vibration-generating component disposed within the housing of the device. The haptic actuator may be activated in response to the same simulated impact data that triggers electrical stimulation or may be activated independently based on event classification. Vibration intensity, frequency, and duration may be defined by firmware-controlled parameters stored in non-volatile memory. In certain embodiments, vibration feedback may simulate non-penetrating impacts, environmental effects, or concussive forces that do not require electrical stimulation. The addition of vibration feedback provides multimodal sensory output within the training environment.

In some embodiments, the method further comprises authenticating incoming activation commands prior to enabling electrical stimulation output. Authentication may include verification of a device pairing identifier stored in non-volatile memory, validation of a cryptographic signature, or confirmation of a session token transmitted from the virtual reality simulator platform. The microcontroller may reject activation commands that fail authentication checks. In certain embodiments, a secure handshake procedure may be required before the device transitions to an armed state capable of delivering stimulation. Authentication procedures may prevent unauthorized devices from transmitting activation commands. This security mechanism ensures that stimulation output is enabled only when verified and authorized control signals are received.

In some embodiments, the method further comprises interrupting stimulation output using a hardware-level fail-safe circuit when activation exceeds a predetermined duration threshold. The hardware-level fail-safe circuit may include a hardware timer configured to measure the duration of active stimulation output. If the measured activation interval exceeds a predefined duration, such as approximately 1 second, 2 seconds, or another selected threshold, the hardware timer may generate a disable signal. The disable signal may be electrically coupled to the stimulation driver circuitry to terminate output independent of firmware execution. In certain embodiments, the fail-safe circuit may also include current-limiting components configured to restrict output current to a predefined maximum amplitude. The presence of hardware-level interruption provides redundancy relative to firmware-based safety enforcement.

In some embodiments, the method further comprises placing the wearable electrical stimulation device into a sleep mode when inactivity is detected by an inertial measurement unit of the wearable electrical stimulation device. The inertial measurement unit may include one or more accelerometers or gyroscopes configured to detect movement of the device. If the inertial measurement unit indicates that movement has fallen below a predefined threshold for a predetermined duration, the microcontroller may transition the device into a low-power state. In the sleep mode, stimulation output channels may be disabled, wireless communication may be reduced or suspended, and processor clock frequency may be lowered. Upon detection of renewed motion, the microcontroller may automatically return the device to an operational state. This motion-based sleep control conserves battery energy and extends operational runtime.

In some embodiments, the multi-stage stimulation sequence comprises an initial high-frequency pulse followed by sustained lower-frequency stimulation. The initial high-frequency pulse may operate within a range of approximately 80 Hz to 150 Hz for a duration between approximately 50 milliseconds and 200 milliseconds. The sustained lower-frequency stimulation may operate within a range of approximately 30 Hz to 70 Hz for a duration between approximately 300 milliseconds and 2 seconds. The transition between stages may be controlled using firmware-based state machines or hardware timers. The amplitude of the sustained phase may be equal to or lower than the amplitude of the initial pulse phase. This staged waveform configuration provides differentiated onset and residual stimulation characteristics.

In some embodiments, the method further comprises limiting stimulation parameters using predefined stimulation profiles stored in the non-volatile memory. The predefined stimulation profiles may correspond to selectable levels such as Basic, Medium, or Rough. Each profile may define maximum allowable current amplitude, pulse width, pulse frequency, and activation duration. When processing simulated impact data, the microcontroller may select a predefined profile corresponding to the severity level of the impact. The selected profile may constrain output parameters regardless of externally requested values. Storage of predefined profiles in non-volatile memory permits firmware updates or customization without hardware modification.

In some embodiments, the method further comprises restoring communication with the virtual reality simulator platform prior to re-enabling the two or more independently addressable electrical stimulation output channels following entry into the safe state. Upon detection of communication loss, the device may disable stimulation output channels and enter a safe state. Before reactivation, the wireless communication module may re-establish a connection with the virtual reality simulator platform using a handshake or pairing verification process. The microcontroller may confirm receipt of valid data packets and authentication credentials prior to re-enabling stimulation output. In certain embodiments, the device may require receipt of a re-arming command before transitioning out of the safe state. This communication restoration procedure ensures controlled reactivation of stimulation functionality following interruption.

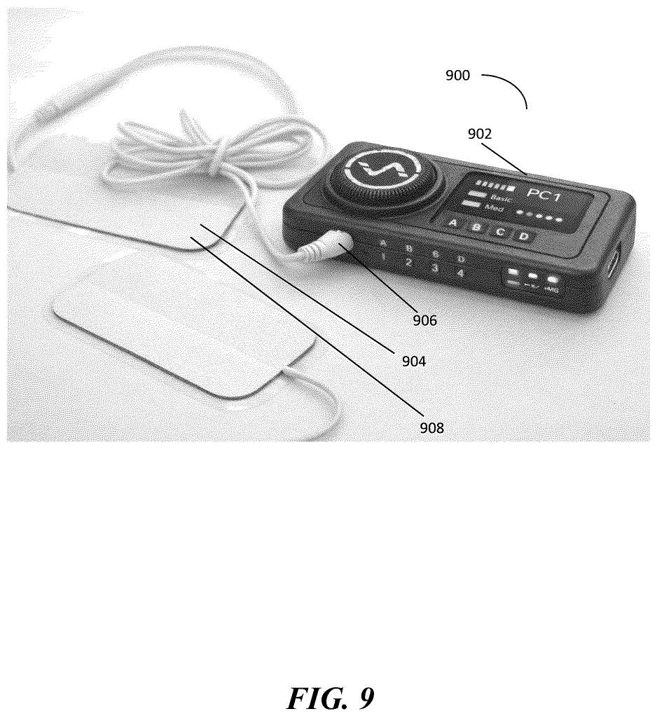

FIG. 9 illustrates an example embodiment of a wearable electrical stimulation device 900 configured for use in a virtual reality training environment. The wearable electrical stimulation device 900 comprises a housing 902 configured to be worn on a user in a secure and stable manner during high-mobility activity. In various embodiments, the housing 902 may be dimensioned for attachment to a belt, waistband, tactical vest, load-bearing harness, or other garment interface. The housing 902 may include a rear-mounted clip, sliding rail interface, snap-lock mechanism, or strap-based retention structure to prevent displacement during rapid movement. The enclosure may be formed from impact-resistant polymer, reinforced composite, anodized aluminum, or other durable material capable of withstanding repeated operational stress. In certain embodiments, the housing 902 may further include environmental sealing features such as gaskets or overmolded elastomeric seals to provide resistance to sweat, moisture, and dust ingress.

The wearable electrical stimulation device 900 further comprises one or more electrodes 904 configured to couple to a body of the user. Each of the one or more electrodes 904 includes a first end 906 electrically connected to circuitry disposed within the housing 902 and an opposite second end 908 configured to contact the user's skin. The first end 906 may be connected via insulated conductive leads, shielded cables, detachable connectors, or pogo pin interfaces that electrically couple to stimulation driver circuitry. The second end 908 may comprise an adhesive hydrogel pad, a conductive polymer pad, a snap-coupled disposable electrode, or a reusable elastomeric contact surface configured to conform to the user's body. In some embodiments, two electrodes may form a stimulation pair per channel to complete a current path through localized muscle groups. Example anatomical placement regions may include the upper chest, lower rib area, shoulder blade region, or lateral torso region to simulate front, rear, or lateral impact sensations.

The circuitry disposed within the housing 902 includes a control board comprising a microcontroller and non-volatile memory. The microcontroller may comprise a 32-bit embedded processor, ARM-based processor, or other programmable processing unit capable of executing firmware instructions in real time. The non-volatile memory may include flash memory, EEPROM, FRAM, or other persistent storage used to retain configuration parameters, stimulation profiles, safety thresholds, and mapping tables. In certain embodiments, the control board may further include analog front-end circuitry for current sensing, voltage monitoring, and signal conditioning. The control board may also include power regulation components such as DC-DC converters, low-dropout regulators, and battery management integrated circuits. In some implementations, the control board may be implemented as a multi-layer printed circuit board designed to isolate high-voltage stimulation traces from low-voltage digital control traces.

The circuitry further comprises four independently addressable electrical stimulation output channels, each comprising a dedicated stimulation driver circuit. Each stimulation driver circuit may include a pulse generation module capable of producing biphasic or monophasic waveforms. The driver circuit may further include a current-limiting stage, switching transistors, and digital control inputs that enable precise regulation of pulse amplitude and duration. The independently addressable configuration permits each channel to be activated independently or concurrently with other channels. In some embodiments, the channels may support current amplitudes in example ranges of approximately 5 mA to 60 mA, pulse widths in example ranges of approximately 50 microseconds to 400 microseconds, and pulse frequencies in example ranges of approximately 20 Hz to 120 Hz. Isolation components such as opto-isolators or transformer-based isolation stages may be incorporated to protect the microcontroller from high-voltage transients generated during stimulation events.

The wearable electrical stimulation device 900 further includes a wireless communication module configured to receive simulated impact data from a virtual reality simulator platform. The wireless communication module may operate using Sub-GHz radio, WiFi at approximately 5 GHz, Bluetooth Low Energy, or other wireless communication protocols configured for low-latency transmission. The simulated impact data may include metadata such as impact location coordinates, intensity values, classification type, and timestamp information. The wireless communication module may communicate with the microcontroller through SPI, UART, I2C, or other digital interface standards. In certain embodiments, encrypted communication protocols may be used to authenticate commands and prevent unauthorized activation. The wireless communication module may also store paired device identifiers in non-volatile memory to enable rapid reconnection during repeated training sessions.

An inertial measurement unit (IMU) is disposed within the housing 902 and configured to detect motion of the wearable electrical stimulation device 900. The IMU may include a multi-axis accelerometer, gyroscope, and optionally a magnetometer to detect movement patterns. Upon detection of prolonged inactivity, such as absence of acceleration exceeding a predefined threshold for a specified duration, the microcontroller may place the device into a sleep mode. The sleep mode may disable stimulation outputs, reduce clock frequency, and deactivate wireless communication to conserve battery power. In certain embodiments, the sleep mode may be triggered after a configurable inactivity period, such as 60 seconds to 10 minutes. Upon detection of renewed motion, the device may automatically return to an operational state.

A power source is disposed within the housing 902 and may comprise a rechargeable lithium-ion battery, lithium polymer battery, or other portable energy storage device. The power source may provide example voltage levels in a range of approximately 3.7 volts to 7.4 volts depending on cell configuration. The device may include a charging interface such as a USB Type-C connector configured for rapid charging. Battery management circuitry may include overcharge protection, over-discharge protection, and temperature monitoring. In certain embodiments, the device may include LED indicators or display elements to indicate battery status and charging progress. The power source may support continuous operation for a predefined duration, such as 2 to 8 hours of active training.

The wearable electrical stimulation device 900 further includes a shutdown actuator configured to interrupt electrical output from the four independently addressable electrical stimulation output channels. The shutdown actuator may comprise a physical push-button switch positioned on an accessible surface of the housing 902. In some embodiments, the shutdown actuator may be recessed or guarded to prevent accidental activation. Activation of the shutdown actuator may generate a hardware interrupt signal that immediately disables the stimulation driver circuits independent of firmware control. In certain implementations, the shutdown actuator may be electrically coupled to a timing-based output disable circuit that physically opens the output path to the electrodes. This configuration provides an immediate and reliable mechanism for terminating stimulation in emergency scenarios.

In operation, the microcontroller processes runtime-simulated impact event data received from the virtual reality simulator platform. Based on the received data, the microcontroller may reassign, during operation, at least one of the four independently addressable electrical stimulation output channels to a selected one of the one or more electrodes. The reassignment may be performed by accessing and updating a reconfigurable channel-to-electrode association table stored in non-volatile memory. The association table may define logical mappings between channel identifiers and electrode positions such as “front left,” “front right,” “rear left,” and “rear right.” Updating the association table enables dynamic remapping without altering physical wiring connections. This runtime reassignment capability allows adaptation to different user configurations or training scenarios.

The microcontroller may selectively activate one or more of the four independently addressable electrical stimulation output channels simultaneously to simulate spatially distinct impact locations. For example, simultaneous activation of two channels may simulate a multi-point ballistic event, while sequential activation may simulate ricochet or staggered impacts. Each channel may operate with distinct stimulation parameters to create varied sensation patterns. The microcontroller may generate a multi-stage stimulation sequence including an initial pulse burst followed by sustained stimulation. In certain embodiments, the initial pulse may comprise a higher-frequency burst in a range of approximately 80 Hz to 150 Hz for a duration of approximately 50 milliseconds to 200 milliseconds, followed by sustained stimulation in a range of approximately 30 Hz to 70 Hz for a duration of approximately 300 milliseconds to 2 seconds. This multi-stage sequence may simulate both immediate impact sensation and residual muscular response.

The firmware executed by the microcontroller may enforce limits on stimulation intensity, pulse width, pulse frequency, and activation duration independent of commands received from the virtual reality simulator platform. Example firmware-enforced limits may restrict maximum current amplitude to less than approximately 60 mA and maximum continuous activation duration to less than approximately 2 seconds. These limits may be stored in non-volatile memory as predefined stimulation profiles such as Basic, Medium, and Rough levels. The microcontroller may prevent activation beyond these limits even if higher intensity values are received from the simulator platform. Upon detection of communication loss with the virtual reality simulator platform, the microcontroller may default the wearable electrical stimulation device 900 to a safe state by disabling the four independently addressable electrical stimulation output channels. The safe state may require re-establishment of authenticated communication before stimulation output can resume.

In an embodiment, the wearable haptic feedback device transitions to a Gen10 control architecture utilizing a V-Armed Board Gen10 as a core processing and control platform. The Gen10 platform replaces prior-generation control circuitry and centralizes stimulation control, wireless communication handling, channel management, and safety enforcement within a unified board architecture. The V-Armed Board Gen10 may include an integrated microcontroller, wireless transceiver module, memory subsystem, and stimulation driver circuitry disposed on a compact printed circuit board. By consolidating these components, the system reduces wiring complexity and improves signal integrity between stimulation outputs and electrode interfaces. For example, rather than utilizing separate boards for communication and stimulation control, the Gen10 board integrates both functions on a single platform, thereby minimizing latency between virtual event detection and physical feedback delivery. In another example, the board may include upgraded processing capability to handle simultaneous multi-channel activation while enforcing safety thresholds in real time.

In one embodiment, the overall device thickness is reduced by approximately fifty percent relative to prior embodiments through mechanical and electrical redesign. The thickness reduction may be achieved by using low-profile stimulation coils, surface-mount components, compact battery cells, and a reconfigured internal component layout. The enclosure may be redesigned to conform more closely to the curvature of a user's body, thereby improving comfort during extended training sessions. For example, a prior housing having a thickness of approximately 24 millimeters may be reduced to approximately 12 millimeters, enabling the device to sit flush against a user's belt or vest. The enclosure may be manufactured using injection-molded polymer, fiber-reinforced composite, or lightweight aluminum alloy to facilitate mass production and durability. In another example, the housing may incorporate internal rib structures to maintain structural rigidity while minimizing material usage and overall weight.

### Expanded Shock Channel Architecture

In certain embodiments, the system increases from two independently addressable electrical stimulation channels to four independently addressable shock channels. Each channel comprises a dedicated stimulation driver circuit electrically coupled to a respective electrode interface positioned on a user's body. The Gen10 control board independently regulates parameters such as pulse amplitude, pulse width, frequency, and burst duration for each channel. This configuration enables simultaneous activation of multiple body regions in response to complex simulated impact events. For example, a simulated lateral impact may trigger activation of both a chest electrode and a shoulder electrode to represent angled ballistic entry. In another example, training software may assign different intensities to separate channels to simulate grazing impacts versus direct hits.

The firmware enables dynamic mapping of output channels to specific electrode positions based on software configuration. Channel mapping may be modified through a graphical user interface without requiring physical reconnection of electrode leads. For example, Channel 1 may initially correspond to a front-left chest pad but may later be reassigned to a rear-right shoulder pad based on updated training scenarios. This dynamic remapping allows the same hardware device to support different vest configurations or anatomical placements. In certain embodiments, the selectable shock intensity profiles, including Basic, Medium, and Rough levels, correspond to predefined parameter sets stored in the non-volatile memory of the control board. Each predefined parameter set may define one or more stimulation characteristics including current amplitude, pulse width, pulse frequency, burst duration, inter-pulse interval, and total activation duration. The parameter sets may be programmed at manufacture, updated through firmware revision, or modified through authenticated configuration commands received from the virtual reality simulator platform. For example, a Basic profile may define a current amplitude in a range of approximately 5 mA to 15 mA, a pulse width in a range of approximately 50 microseconds to 150 microseconds, a pulse frequency in a range of approximately 20 Hz to 50 Hz, and a total activation duration of approximately 100 milliseconds to 500 milliseconds. In another example, a Medium profile may define a current amplitude in a range of approximately 15 mA to 35 mA, a pulse width in a range of approximately 100 microseconds to 250 microseconds, a pulse frequency in a range of approximately 40 Hz to 80 Hz, and a total activation duration of approximately 250 milliseconds to 1.0 second. In a further example, a Rough profile may define a current amplitude in a range of approximately 30 mA to 60 mA, a pulse width in a range of approximately 200 microseconds to 400 microseconds, a pulse frequency in a range of approximately 60 Hz to 120 Hz, and a total activation duration of approximately 500 milliseconds to 2.0 seconds.

In some embodiments, the profiles may further include multi-stage parameter transitions, such as an initial high-frequency pulse burst (for example, 80 Hz to 150 Hz for 50 to 150 milliseconds) followed by a sustained lower-frequency stimulation phase (for example, 30 Hz to 70 Hz for 300 milliseconds to 1.5 seconds) to simulate both impact and residual muscular response. The firmware may enforce maximum ceilings for each parameter independent of simulator commands, such as limiting peak current to less than approximately 60 mA, pulse width to less than approximately 400 microseconds, and continuous activation duration to less than approximately 2.0 seconds. The predefined parameter sets may be stored in non-volatile memory as structured data tables indexed by profile identifier, thereby enabling rapid profile switching without recalculating stimulation parameters during runtime. In certain embodiments, the microcontroller may interpolate between parameter sets to generate intermediate intensity levels while remaining within firmware-enforced safety limits.

These predefined intensity profiles allow controlled escalation of training realism while maintaining compliance with safety constraints and preventing unauthorized modification of stimulation parameters beyond permitted operating ranges. In an illustrative example, the Basic level may limit peak current and pulse duration for beginner trainees, whereas the Rough level may increase both parameters within firmware-enforced safety limits for advanced tactical simulations.

In some embodiments, the device integrates optional vibration feedback in addition to electrical stimulation. The vibration mechanism may comprise one or more haptic actuators, such as eccentric rotating mass actuators or linear resonant actuators, electrically controlled by the Gen10 board. The vibration output may operate independently or synchronously with electrical pulses to simulate layered sensory effects. For example, a near-miss event may activate only a vibration actuator without electrical stimulation to represent proximity shockwave effects. In another example, an initial sharp electrical pulse may be followed by sustained vibration to mimic residual muscle tremor after impact. This combined feedback architecture enables simulation of a broader range of tactical scenarios while preserving modularity in hardware design.

### User Interface Enhancements

In certain embodiments, the user interface includes a compact LED-based status indication system integrated into the enclosure. One or more light-emitting diodes are configured to display device state information in real time. The LEDs may use different colors or blink patterns to indicate operational modes, such as power-on state, pairing mode, active connection, or fault condition. For example, a steady green light may indicate successful pairing with a simulator host, while a flashing blue light may indicate pairing mode. A red flashing indicator may signal low battery status or a fault condition requiring user attention. This visual interface enables rapid state assessment during high-intensity training scenarios without requiring removal of the device.

In some embodiments, the LED interface further displays shock intensity level selection and paired computing device identification. The system may display identifiers such as PC1, PC2, or other alphanumeric indicators corresponding to a specific simulator host. This feature is particularly useful in multi-user training environments where several trainees operate within the same facility. For example, when a trainee connects to a designated training station, the device may illuminate a coded LED pattern corresponding to that station identifier. Clear visual pairing and connection indicators reduce configuration errors and improve operational clarity. In another example, the LED display may momentarily flash a confirmation pattern upon successful secure authentication with the host system.

### Communication and Device Control

The system is configured to operate using Sub-GHz wireless communication and/or WiFi operating at approximately 5 GHz for activation and control. The communication module may support bidirectional data exchange between the wearable device and a simulator host platform. Sub-GHz communication may provide long-range, low-latency signaling within indoor tactical facilities, while WiFi 5 GHz communication may enable high-throughput integration with networked simulation systems. For example, a law enforcement training facility may utilize Sub-GHz signaling for direct shot detection triggers, whereas a military simulation center may utilize WiFi integration for synchronized multi-user event coordination. The communication module may include encryption and authentication mechanisms to prevent unauthorized activation. In some embodiments, communication priority protocols ensure that safety commands override all stimulation commands.

Paired device information is stored in non-volatile memory to retain credentials across power cycles and battery depletion events. This stored pairing data allows the device to automatically reconnect to an authorized simulator platform upon restart. For example, a trainee assigned to a specific workstation may power down the device between sessions and later resume operation without re-pairing. Secure activation logic implemented in firmware verifies incoming command authenticity prior to enabling stimulation outputs. In an example scenario, the device may reject activation commands that do not match stored encryption keys or pairing identifiers. This architecture enhances operational integrity in environments where multiple wireless systems operate simultaneously.

### Safety Architecture and Control Logic

The Gen10 firmware enforces predefined limits on stimulation intensity, pulse duration, and activation frequency to maintain safe operational boundaries. These limits may be implemented through hard-coded parameter ceilings within firmware memory. For example, the firmware may prevent pulse duration from exceeding a maximum allowable threshold regardless of incoming external commands. Similarly, maximum current amplitude may be restricted to a medically safe range consistent with TENS device standards. The firmware may also enforce cooldown intervals between successive activations to prevent repetitive over-stimulation. These controls operate continuously and independently of simulator-generated input.

In addition to firmware safeguards, a hardware-level fail-safe mechanism is incorporated to prevent continuous or runaway activation. The fail-safe may include a watchdog timer configured to reset stimulation circuitry if activation persists beyond a predefined duration. In another embodiment, a hardware current-limiting circuit may physically interrupt output if abnormal current flow is detected. For example, if a communication error causes repeated activation signals, the hardware interrupt mechanism may automatically disable output channels. The system is further configured to default to a safe state upon communication loss or signal corruption. Upon detection of wireless disconnection, the device disables all stimulation outputs and vibration actuators until a verified communication link is re-established, thereby ensuring fail-safe operation in dynamic training environments.

### EXAMPLES

Embodiment 1. A wearable electrical stimulation device for virtual reality training, comprising: a housing configured to be worn on a user; one or more electrodes having a first end electrically connected to circuitry disposed within the housing and an opposite second end configured to couple to a body of the user; the circuitry disposed within the housing, the circuitry comprising: a control board comprising a microcontroller and non-volatile memory; four independently addressable electrical stimulation output channels each comprising a dedicated stimulation driver circuit configured to deliver transcutaneous electrical nerve stimulation signals to the one or more electrodes via the first end; a wireless communication module configured to receive simulated impact data from a virtual reality simulator platform; an inertial measurement unit configured to detect motion and initiate a sleep mode when the wearable electrical stimulation device is inactive; a power source disposed within the housing; and a shutdown actuator configured to interrupt electrical output from the four independently addressable electrical stimulation output channels; wherein the microcontroller is configured to: process runtime simulated impact event data received from the virtual reality simulator platform; reassign, during operation, at least one of the four independently addressable electrical stimulation output channels to a selected one of the one or more electrodes by accessing and updating a reconfigurable channel-to-electrode association table stored in the non-volatile memory; selectively activate one or more of the four independently addressable electrical stimulation output channels simultaneously to simulate spatially distinct impact locations; generate a multi-stage stimulation sequence including an initial pulse followed by sustained stimulation; enforce firmware-based limits on stimulation intensity, pulse width, pulse frequency, and activation duration independent of commands received from the virtual reality simulator platform; and default the wearable electrical stimulation device to a safe state by disabling the four independently addressable electrical stimulation output channels upon detection of communication loss.

Embodiment 2. The wearable electrical stimulation device of embodiment 1, wherein at least two of the four independently addressable electrical stimulation output channels are configured to deliver differential stimulation to a front portion and a back portion of the body of the user via the one or more electrodes.

Embodiment 3. The wearable electrical stimulation device of embodiment 1, further comprising at least one haptic actuator configured to provide optional vibration feedback in response to the simulated impact data.

Embodiment 4. The wearable electrical stimulation device of embodiment 3, wherein the at least one haptic actuator operates synchronously with at least one of the four independently addressable electrical stimulation output channels.

Embodiment 5. The wearable electrical stimulation device of embodiment 3, wherein the at least one haptic actuator operates independently of the four independently addressable electrical stimulation output channels.

Embodiment 6. The wearable electrical stimulation device of embodiment 1, further comprising a stimulation output interruption circuit electrically coupled between the two or more independently addressable electrical stimulation output channels and the one or more electrodes, the stimulation output interruption circuit configured to disable electrical output when an activation duration exceeds a predetermined duration threshold independent of software control.

Embodiment 7. The wearable electrical stimulation device of embodiment 6, wherein the stimulation output interruption circuit comprises at least one of a hardware timer circuit or a current-limiting circuit; wherein the hardware timer circuit comprising a clock source and a counter configured to measure an activation interval of the two or more independently addressable electrical stimulation output channels and generate a reset or disable signal when the measured activation interval exceeds a predetermined threshold.

Embodiment 8. The wearable electrical stimulation device of embodiment 1, wherein the housing has a fastener configured to removably couple to at least a portion of the user.

Embodiment 9. The wearable electrical stimulation device of embodiment 8, wherein the fastener comprises a belt clip.

Embodiment 10. The wearable electrical stimulation device of embodiment 8, wherein the fastener comprises at least one of a clasp, hook, strap interface, or magnetic coupling mechanism.

Embodiment 11. A method of providing electrical stimulation feedback in a virtual reality training environment, comprising: receiving simulated impact data from a virtual reality simulator platform at a wearable electrical stimulation device comprising a housing, one or more electrodes electrically coupled to circuitry disposed within the housing, a microcontroller, non-volatile memory, and two or more independently addressable electrical stimulation output channels; processing runtime simulated impact event data using the microcontroller; reassigning, during operation of the wearable electrical stimulation device, at least one of the two or more independently addressable electrical stimulation output channels to a selected one of the one or more electrodes by accessing and updating a channel-to-electrode association table stored in the non-volatile memory; concurrently activating at least two of the two or more independently addressable electrical stimulation output channels to simulate spatially distinct impact locations on a body of a user; generating a multi-stage stimulation sequence including an initial pulse followed by sustained stimulation; enforcing firmware-based limits on stimulation intensity, pulse width, pulse frequency, and activation duration independent of commands received from the virtual reality simulator platform; and defaulting the wearable electrical stimulation device to a safe state by disabling the two or more independently addressable electrical stimulation output channels upon detection of communication loss.

Embodiment 12. The method of embodiment 11, wherein the two or more independently addressable electrical stimulation output channels comprise four independently addressable electrical stimulation output channels.

Embodiment 13. The method of embodiment 11, further comprising delivering differential stimulation using at least two of the two or more independently addressable electrical stimulation output channels to a front portion and a back portion of the body of the user.

Embodiment 14. The method of embodiment 11, further comprising generating vibration feedback using at least one haptic actuator of the wearable electrical stimulation device.

Embodiment 15. The method of embodiment 11, further comprising authenticating incoming activation commands prior to enabling electrical stimulation output.

Embodiment 16. The method of embodiment 11, further comprising interrupting stimulation output using a hardware-level fail-safe circuit when activation exceeds a predetermined duration threshold.

Embodiment 17. The method of embodiment 11, further comprising placing the wearable electrical stimulation device into a sleep mode when inactivity is detected by an inertial measurement unit of the wearable electrical stimulation device.

Embodiment 18. The method of embodiment 11, wherein the multi-stage stimulation sequence comprises an initial high-frequency pulse followed by sustained lower-frequency stimulation.

Embodiment 19. The method of embodiment 11, further comprising limiting stimulation parameters using predefined stimulation profiles stored in the non-volatile memory.

Embodiment 20. The method of embodiment 11, further comprising restoring communication with the virtual reality simulator platform prior to re-enabling the two or more independently addressable electrical stimulation output channels following entry into the safe state.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but are not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. What is claimed is: A wearable electrical stimulation device for virtual reality training, comprising:
a housing configured to be worn on a user;
one or more electrodes having a first end electrically connected to circuitry disposed within the housing and an opposite second end configured to couple to a body of the user;
the circuitry disposed within the housing, the circuitry comprising:
a control board comprising a microcontroller and non-volatile memory;
four independently addressable electrical stimulation output channels each comprising a dedicated stimulation driver circuit configured to deliver transcutaneous electrical nerve stimulation signals to the one or more electrodes via the first end;
a wireless communication module configured to receive simulated impact data from a virtual reality simulator platform;
an inertial measurement unit configured to detect motion and initiate a sleep mode when the wearable electrical stimulation device is inactive;
a power source disposed within the housing; and
a shutdown actuator configured to interrupt electrical output from the four independently addressable electrical stimulation output channels;
wherein the microcontroller is configured to:
process runtime simulated impact event data received from the virtual reality simulator platform;
reassign, during operation, at least one of the four independently addressable electrical stimulation output channels to a selected one of the one or more electrodes by accessing and updating a reconfigurable channel-to-electrode association table stored in the non-volatile memory;
selectively activate one or more of the four independently addressable electrical stimulation output channels simultaneously to simulate spatially distinct impact locations;
generate a multi-stage stimulation sequence including an initial pulse followed by sustained stimulation;
enforce firmware-based limits on stimulation intensity, pulse width, pulse frequency, and activation duration independent of commands received from the virtual reality simulator platform; and
default the wearable electrical stimulation device to a safe state by disabling the four independently addressable electrical stimulation output channels upon detection of communication loss.

2. The wearable electrical stimulation device of claim 1, wherein at least two of the four independently addressable electrical stimulation output channels are configured to deliver differential stimulation to a front portion and a back portion of the body of the user via the one or more electrodes.

3. The wearable electrical stimulation device of claim 1, further comprising at least one haptic actuator configured to provide optional vibration feedback in response to the simulated impact data.

4. The wearable electrical stimulation device of claim 3, wherein the at least one haptic actuator operates synchronously with at least one of the four independently addressable electrical stimulation output channels.

5. The wearable electrical stimulation device of claim 3, wherein the at least one haptic actuator operates independently of the four independently addressable electrical stimulation output channels.

6. The wearable electrical stimulation device of claim 1, further comprising a stimulation output interruption circuit electrically coupled between the two or more independently addressable electrical stimulation output channels and the one or more electrodes, the stimulation output interruption circuit configured to disable electrical output when an activation duration exceeds a predetermined duration threshold independent of software control.

7. The wearable electrical stimulation device of claim 6, wherein the stimulation output interruption circuit comprises at least one of a hardware timer circuit or a current-limiting circuit;
wherein the hardware timer circuit comprises a clock source and a counter configured to measure an activation interval of the two or more independently addressable electrical stimulation output channels and generate a reset or disable signal when the measured activation interval exceeds a predetermined threshold.

8. The wearable electrical stimulation device of claim 1, wherein the housing has a fastener configured to removably couple to at least a portion of the user.

9. The wearable electrical stimulation device of claim 8, wherein the fastener comprises a belt clip.

10. The wearable electrical stimulation device of claim 8, wherein the fastener comprises at least one of a clasp, hook, strap interface, or magnetic coupling mechanism.

11. A method of providing electrical stimulation feedback in a virtual reality training environment, comprising:
receiving simulated impact data from a virtual reality simulator platform at a wearable electrical stimulation device comprising a housing, one or more electrodes electrically coupled to circuitry disposed within the housing, a microcontroller, non-volatile memory, and two or more independently addressable electrical stimulation output channels;
processing runtime simulated impact event data using the microcontroller;
reassigning, during operation of the wearable electrical stimulation device, at least one of the two or more independently addressable electrical stimulation output channels to a selected one of the one or more electrodes by accessing and updating a channel-to-electrode association table stored in the non-volatile memory;
concurrently activating at least two of the two or more independently addressable electrical stimulation output channels to simulate spatially distinct impact locations on a body of a user;
generating a multi-stage stimulation sequence including an initial pulse followed by sustained stimulation;
enforcing firmware-based limits on stimulation intensity, pulse width, pulse frequency, and activation duration independent of commands received from the virtual reality simulator platform; and
defaulting the wearable electrical stimulation device to a safe state by disabling the two or more independently addressable electrical stimulation output channels upon detection of communication loss.

12. The method of claim 11, wherein the two or more independently addressable electrical stimulation output channels comprise four independently addressable electrical stimulation output channels.

13. The method of claim 11, further comprising delivering differential stimulation using at least two of the two or more independently addressable electrical stimulation output channels to a front portion and a back portion of the body of the user.

14. The method of claim 11, further comprising generating vibration feedback using at least one haptic actuator of the wearable electrical stimulation device.

15. The method of claim 11, further comprising authenticating incoming activation commands prior to enabling electrical stimulation output.

16. The method of claim 11, further comprising interrupting stimulation output using a hardware-level fail-safe circuit when activation exceeds a predetermined duration threshold.

17. The method of claim 11, further comprising placing the wearable electrical stimulation device into a sleep mode when inactivity is detected by an inertial measurement unit of the wearable electrical stimulation device.

18. The method of claim 11, wherein the multi-stage stimulation sequence comprises an initial high-frequency pulse followed by sustained lower-frequency stimulation.

19. The method of claim 11, further comprising limiting stimulation parameters using predefined stimulation profiles stored in the non-volatile memory.

20. The method of claim 11, further comprising restoring communication with the virtual reality simulator platform prior to re-enabling the two or more independently addressable electrical stimulation output channels following entry into the safe state.
